(19) United States
(12) Patent Application Publication
(10) Pub. No.: US 2011/0001684 A1
(43) Pub. Date: Jan. 6, 2011

(54) MULTIRESONANCE HELIX ANTENNA

(75) Inventor: Tuomo HAARAKANGAS, Oulu (FI)

Correspondence Address: YOUNG & THOMPSON, 209 Madison Street, Suite 500, Alexandria, VA, 22314, US

(73) Assignee: ELEKTROBIT WIRELESS COMMUNICATIONS, Oulu (FI)

(21) Appl. No.: 12/496,960

(22) Filed: Jul. 2, 2009

(51) Int. Cl. H01Q 1/36

(52) U.S. Cl. 343/895

(57) ABSTRACT

A helix antenna for satellite connections of mobile devices is to be fed from above, and all its radiators are side by side on a same geometric cylindrical surface. The antenna has at least two resonances. In the case of two-resonance every second radiator resonates at a lower frequency and the rest of the radiators at another, higher frequency, the frequency difference being based on the difference in the physical length of the radiators. One conductor of the feed line of the antenna is connected directly to one half of the radiators and the other conductor to the other half of the radiators. No separate feed circuit for the phase shifts is required in an antenna with plurality of helix radiators, because the phasing can be implemented by the positioning of the radiators and the fine tuning of their length. The antenna structure is simple, and case its production costs are relatively low.

The invention relates to a helix antenna, which has at least two usable resonances, the antenna being especially aimed for the satellite connections of mobile devices.

### BACKGROUND OF THE INVENTION

The antenna of a mobile device has to naturally be relatively small-sized. This means in the case of the satellite communication demanding antenna design because of the long distance between the connection parties. In practice the different helical structures are most common. Beside a reasonable small size, also the circular polarization used generally in the satellite systems and a wide radiation beam are obtained by those structures. A problem in the helix antennas is their small bandwidth especially when the helix is made to be small-sized.

FIGS. 1 and 2 show dualband helix antennas for satellite connections, known from the publication U.S. Pat. No. 6,653,987. The antenna 100 in FIG. 1 comprises four radiating elements, or radiators 121, 122, 123, 124 on the surface of a cylindrical dielectric support pipe 101. Thus the antenna is a so called quadrafilar. The feed points of the radiators are located at the lower end of the structure in a circle at regular intervals, and each radiator forms about one turn on the way from the lower end to upper end of the structure. To improve the circular polarization, the radiators are fed as phased: When the phase of the carrier in some radiator is marked 0°, the phases of the carriers of the radiators next in order are 90°, 180°, and 270°. The phase differences are realized in a feed circuit FNW, to which the feed line FL of the whole antenna comes, and from which circuit the feed lines of the radiators start. The feed circuit is typically implemented by the hybrids, which consist of quarter wave transmission lines. At the lower end of the antenna there is a ground plane 110 perpendicular to the axis of the helixes, which plane functions as a reflector for improving the directivity of the radiation. The outer conductors of the feed lines of the radiators are connected to the ground plane. Its diameter is about 30% of the radiation wavelength.

Each radiator of the antenna 100 is divided to two parts by a separate resonance circuit, as the resonance circuit 131 of the first radiator 121. By means of the resonance circuits the antenna is made as a dualband one. They are of parallel type and the natural frequency of each of them is in the upper operating band of the antenna, in which case a resonance circuit ‘cuts’ the radiator in question at the frequencies of the upper operating band. The electric length of the radiators is then at the frequencies of the upper operating band smaller than at the frequencies of the lower operating band. The lengths are naturally chosen so that the whole antenna has a resonance both in the specified lower and upper operating band.

The antenna 200 shown in FIG. 2 comprises four radiators 221, 222, 223, 224 on the surface of a cylindrical dielectric support pipe 201, and each radiator forms about one turn on the way from the lower end to upper end of the structure, as in FIG. 1. Similarly, the antenna is made as a dualband one by means of the parallel resonance circuits, as the resonance circuit 231 of the first radiator 221. The feed points of the radiators are in this case located at the upper end of the structure in a circle at regular intervals. The feed lines of the radiators start also in this case from the feed circuit FNW realizing the phase shifts, and the lines are led to the upper end of the antenna within a relatively thin pipe 205, which is located at the axis of the support pipe 201. Because of the different feed method in respect of FIG. 1, no ground plane is needed in the antenna 200 for improving the directivity.

In this description and claims the ‘lower end’ and ‘upper end’ of an antenna are defined in accordance with the direction of the radiation so that the helix axis from the lower end to the upper end is the middle direction of the radiation beam. The feed ‘from below’ means that the feed points of the radiators are located at the lower end of the antenna and the feed ‘from above’ means that the feed points of the radiators are located at the upper end of the antenna. Thus the antenna in FIG. 1 is to be fed from below and the antenna in FIG. 2 is to be fed from above.

A disadvantage of the structures like in FIGS. 1 and 2 is that a separate feed circuit is required in them for realizing the phase differences. In addition, the dualband feature requires resonance circuits, which further increases the number of components and production stages.

The dualband feature or more generally two-resonance feature of a helix antenna can be implemented also in other ways. From the publication U.S. Pat. No. 5,828,348 an octafilar helix antenna is known, in which four radiators resonate at a certain frequency and other four radiators at another frequency. The latter radiators are parasitic and are interlaced with the former ones so that every second radiator belongs to one group of four radiators. A disadvantage of the antenna is that its feed requires a phase shift circuit like in the case of FIG. 1. Also impedance transformers have to be included in the feed circuit, because the impedance of the structure interlaced in accordance with the publication is low. In addition, the efficiency of the antenna remains relatively low.

It is also known to implement two resonances by using two quadrafilar structures one within the other. Therefore, the radius of the helixes in the inner quadrafilar is shorter than in the outer quadrafilar, and it resonates at a higher frequency. A disadvantage of the structures is that it is complicated, which means relatively high production costs. In addition the quadrafilars degrade the radiation of each other, which lowers the efficiency.

### SUMMARY OF THE INVENTION

An object of the invention is to alleviate the disadvantages associated with the prior art. The helix antenna according to the invention is characterized in that which is specified in the independent claim 1. Some advantageous embodiments of the invention are specified in the other claims.

The basic idea of the invention is as follows: The helix antenna is to be fed from above, and all its radiators are side by side on a same geometric cylindrical surface. The antenna has at least two resonances. In the case of two-resonance every second radiator resonates at a lower frequency and the rest of the radiators at another, higher frequency, the frequency difference being based on the difference in the physical length of the radiators. The exact length of the radiators is chosen for their optimum phasing. One conductor of the feed line of the antenna is connected directly to one half of the radiators and the other conductor to the other half of the radiators, each half being consisted of the radiators which are side by side.

The invention has the advantage that no separate feed circuit for the phase shifts is required in an antenna with plurality of helix radiators. This is due to the positioning of the radiators, the fine tuning of their length and that they are to be fed from above. Another advantage of the invention is that a multi-resonance structure is obtained without separate additional components. A further advantage of the invention is that the characteristic efficiency and good polarization and radiation pattern of the antenna type in question is obtained at each resonance frequency. The antenna structure is simple, in which case its production costs are relatively low.

### BRIEF DESCRIPTION OF THE DRAWINGS

The invention is described in detail below. The description refers to the enclosed drawings, in which

FIG. 1 presents an example of the known two-resonance helix antenna,

FIG. 2 presents another example of the known two-resonance helix antenna,

FIGS. 3a,b present an example of the two-resonance helix antenna according to the invention,

FIG. 4 presents a second example of the two-resonance helix antenna according to the invention,

FIG. 5 presents a third example of the two-resonance helix antenna according to the invention, and

FIG. 6 presents an example of a three-resonance helix antenna according to the invention.

### DETAILED DESCRIPTION OF THE INVENTION

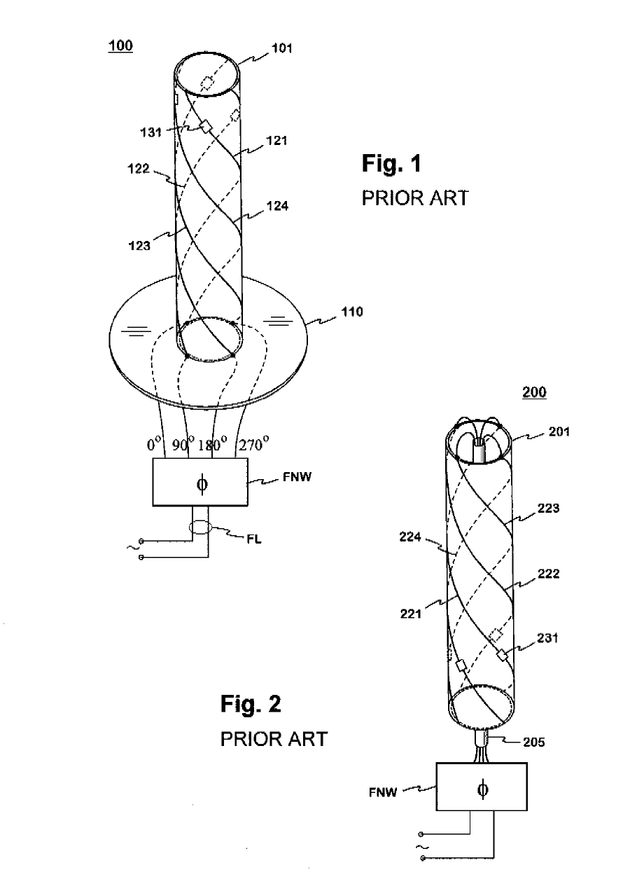

FIGS. 1 and 2 were already described in connection with the description of the prior art.

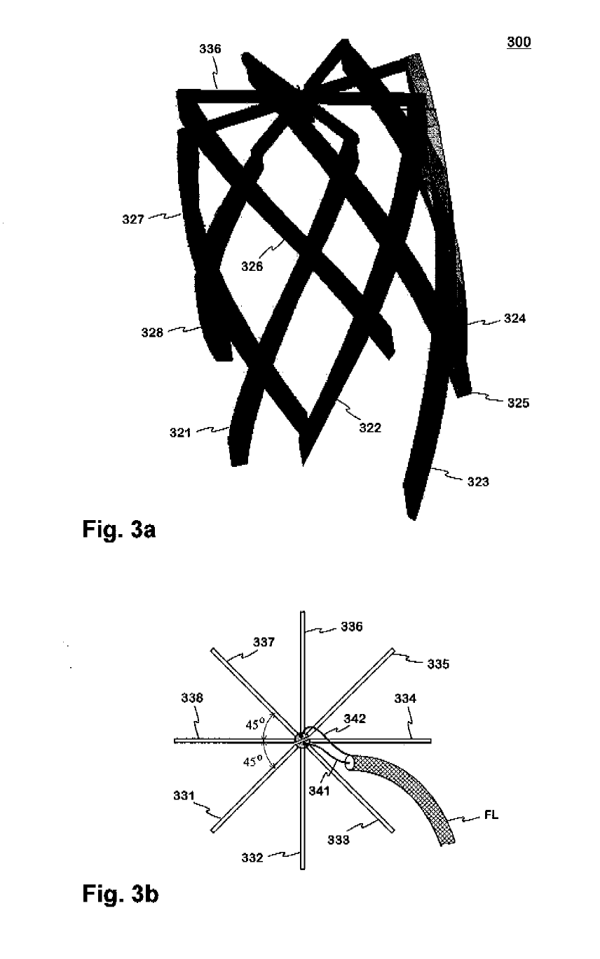

FIG. 3a shows an example of the helix antenna according to the invention. The antenna 300 comprises eight helical radiators 321-328 side by side on a same geometric cylindrical surface, the antenna then being octafilar by type. ‘Side by side’ means that the radiators start towards the same direction from a substantially same geometric plane perpendicular to the axis of the cylindrical surface, or the antenna axis. Each radiator is supported from its upper end to the antenna hub by a conductive arm, as the arm 336 of the sixth radiator 326. The antenna hub is on the antenna axis at the upper end of the antenna. Each arm functions as the feed conductor of one radiator at the same time, the antenna is then to be fed from above. An arm and a radiator form in this example a rigid object so that the antenna is wholly air-insulated and has no dielectric support parts.

The radiators are open at their lower end, or tail end seen from the feed. In other words the tail ends are ‘in air’. The twist of the radiators is relatively small, about a quarter of one turn. For implementing two resonance frequencies, a lower one and upper one, there occurs two radiator lengths. Every second radiator, the first 321, third 323, fifth 525 and seventh 327 radiator in order, form a group, in which the physical length of the radiators is greater than in the second group formed by the second 322, fourth 324, sixth 526 and eighth 328 radiator. In principle the longer radiators naturally resonate at the lower frequency and the shorter ones at the upper frequency. If the resonance frequencies are close to each other, the physical lengths of the radiators corresponding to them may in practice be interlaced.

In this example the order of magnitude of the length of each radiator is a quarter of the wavelength, which corresponds to its use frequency. The length could also be e.g. about three quarters of the wavelength.

FIG. 3b shows the antenna of FIG. 3a from above without the radiators. Thus the arms 331-338 of the radiators and the antenna hub are visible in it. In addition, the feed line FL of the antenna has been drawn in the figure, which line in fact travels within the antenna structure in the middle of the radiators. It appears from the position of the arms that the radiators are in this case at regular intervals, that is in each pair of adjacent radiators the angle between the radiators is 45 degrees. The angle between two radiators means the angle between the straight lines drawn from these radiators to the antenna axis in the plane of the cross section of the antenna.

One conductor 341 of the feed line FL is connected in said hub to the first 331, second 332, third 333 and fourth 334 arm and through them to the corresponding radiators. The other conductor 342 of the feed line is connected in the hub to the fifth 335, sixth 336, seventh 337 and eighth 338 arm and through them to the corresponding radiators. The first, second, third and fourth radiator form then an array, which is galvanically isolated from the array formed by the fifth, sixth, seventh and eighth radiator. These arrays are located on different sides of the geometric surface, which goes through the antenna axis and between the first and last radiator and between two opposite symmetrically located radiators. The feed line is then connected directly to the radiating structure without any separate phase shift circuit. The phasing of the radiators is implemented by means of their feed from above, their positioning and fine tuning of their length.

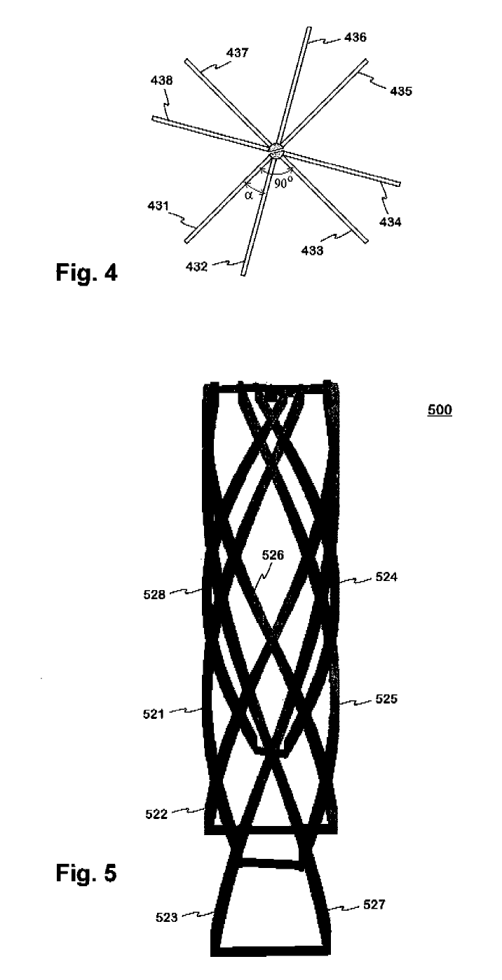

FIG. 4 shows a modification of the antenna according to FIGS. 3a and 3b from above without radiators. Thus the arms 431-438 of the radiators and the antenna hub are visible in it. The difference in respect of the previous example is that now the radiators are not at regular intervals. The four radiators corresponding to one resonance frequency are also in this case at 90 degrees intervals, at least nearly. Instead the other group of four radiators have been turned so that the angle α between e.g. the first and second radiator is substantially smaller than 45 degrees.

FIG. 5 shows a third example of the helix antenna according to the invention. The antenna 500 comprises eight helical radiators 521-528 to be fed from above and being positioned side by side on a same geometric cylindrical surface, as in FIG. 3a. The substantial difference in respect of FIG. 3a is that the radiators are now ‘short-circuited’ at their tail ends. The short-circuit means here that the tail end of each radiator 522; 523 is connected to the tail end of the opposite radiator 526; 527. The opposite radiators mean two radiators, between which there is an angle of 180 degrees. In this example the order of magnitude of the length of each radiator is a half of the wavelength, which corresponds to its use frequency. The length could also be e.g. about the whole wavelength.

It is noticed from FIG. 5 that for example the third 523 and fifth 525 radiator have a somewhat different length, although both of them correspond to the lower resonance frequency. This kind of differences in length relate to the phasing optimization of the radiators.

More generally, regardless of the matter if the radiators are short-circuited or not, the radiators in each radiator pair formed by the opposite radiators have the same length, and the length of the radiators in at least one such a radiator pair can differ from the length of the radiators in another radiator pair, which pair is for the same resonance frequency.

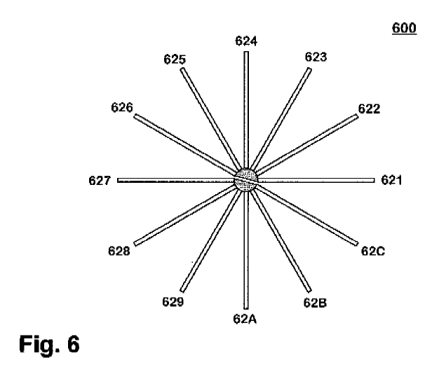

FIG. 6 shows a fourth example of the helix antenna according to the invention. The antenna 600 is presented from above without radiators, for which reason only the arms of the radiators and the antenna hub are visible in it, as in FIGS. 3b and 4. The antenna 600 comprises twelve radiators, and it has three usable resonences.

Each third radiator 621, 624, 627, 62A in order resonate at a first resonance frequency, next each third radiator 622, 625, 628, 62B resonate at a second resonance frequency and the rest of the radiators 623, 626, 629, 62C resonate at a third resonance frequency. One conductor of the feed line of the antenna is connected to the array formed by the radiators 621-626 located side by side, and the other conductor of the feed line to another array formed by the radiators 627-62C located side by side.

Above examples of the helix antenna according to the invention are described. The antenna can differ from what is presented in its structural details, such as the shape and location of the radiators. For example, the radiators for a resonance frequency of the antenna are not necessarily located precisely at 90 degrees intervals from each other. The antenna can be dimensioned so that its resonance frequencies are close to each other constituting one united, relatively wide operating band. The antenna can be dimensioned also so that its resonance frequencies are relatively far from each other constituting at least two separate operating bands. Further the material of the inner space of the antenna can be, except air, also partly or fully some dielectric material. The inventive idea can be applied in different ways within the limits defined by the independent claim 1.

1. A helix antenna to be fed from above, which comprises at least two groups radiators, each group being for implementing a certain resonance frequency, wherein its radiators are located side by side on a same geometric cylindrical surface, and one half of the radiators of each said group is intended to connect directly to one conductor of a feed line of the antenna and the other half of the radiators of each said group is intended to connect directly to the other conductor of the feed line of the antenna.

2. A helix antenna according to claim 1, the radiators, which are for a certain resonance frequency, being located at 90 degrees intervals on said cylindrical surface.

3. A helix antenna according to claim 1, the number of the radiators being eight and the number of the resonance frequencies being two, in which case the first, third, fifth and seventh radiator in order have lower resonance frequency, and the second, fourth, sixth and eighth radiator have upper resonance frequency, and the first, second, third and fourth radiator are intended to connect directly to one conductor of a feed line of the antenna, and the fifth, sixth, seventh and eighth radiator are intended to connect directly to the other conductor of a feed line of the antenna.

4. A helix antenna according to claim 3, wherein its radiators are located at regular intervals, or at 45 degrees intervals, on said cylindrical surface.

5. A helix antenna according to claim 3, wherein an angle between the first and second radiator is substantially smaller than 45 degrees.

6. A helix antenna according to claim 1, wherein its each radiator is open at lower end, or tail end.

7. A helix antenna according to claim 6, the order of magnitude of the length of each radiator being a quarter of the wavelength, which corresponds to its use frequency.

8. A helix antenna according to claim 1, the lower end, or tail end, of each radiator being connected to the tail end of opposite radiator, or radiator, the angle of which in respect of the first-mentioned radiator is 180 degrees.

9. A helix antenna according to claim 8, the order of magnitude of the length of each radiator being a half of the wavelength, which corresponds to its use frequency.

10. A helix antenna according to claim 1, the radiators in each radiator pair formed by the opposite radiators having the same length, and the length of the radiators in at least one such a radiator pair can differ from the length of the radiators in another radiator pair, which pair is for the same resonance frequency.

11. A helix antenna according to claim 1, the number of the radiators being twelve and the number of the resonance frequencies being three, in which case the first, fourth, seventh and tenth radiator in order have a first resonance frequency, the second, fifth, eighth and eleventh radiator in order have a second resonance frequency, and the third, sixth, ninth and twelfth radiator in order have a third resonance frequency.

12. A helix antenna according to claim 1, wherein its radiators are rigid objects, between which and within the antenna air being the only insulation.

13. A helix antenna according to claim 1, at least a part of inner space of the antenna being filled by some dielectric material.
